(19) United States
(12) Patent Application Publication
(10) Pub. No.: US 2024/0241277 A1
(43) Pub. Date: Jul. 18, 2024

(54) INVERSION METHOD AND SYSTEM FOR SEISMIC WAVELET AND REFLECTION COEFFICIENT

(71) Applicant: Xi'an Jiaotong University, Xi'an (CN)

(72) Inventors: Jinghuai GAO, Xi'an (CN); Wenhao XU, Xi'an (CN); Yajun TIAN, Xi'an (CN)

(21) Appl. No.: 18/359,160

(22) Filed: Jul. 26, 2023

(30) Foreign Application Priority Data
Aug. 2, 2022 (CN) 202210922138.1

(51) Int. Cl. G01V 1/30

(52) U.S. Cl. CPC G01V 1/307

(57) ABSTRACT

An inversion method for seismic wavelets and reflection coefficients, in which it is assumed that the seismic wavelets have compact support, and are smooth, and the reflection coefficients are relatively sparse. Corresponding optimization problems for the inversion of seismic wavelet and reflection coefficient sequence are constructed. By using alternating iteration, the joint inversion problem of the seismic wavelets and the reflection coefficients, which is based on compact smoothness and relative sparsity, is divided into a seismic wavelet inversion subproblem and a reflection coefficient inversion subproblem. The two subproblems are solved using a proximal algorithm. A system for implementing the inversion method is also provided herein.

### CROSS-REFERENCE TO RELATED APPLICATIONS

This application claims the benefit of priority from Chinese Patent Application No. 202210922138.1, filed on Aug. 2, 2022. The content of the aforementioned application, including any intervening amendments thereto, is incorporated herein by reference in its entirety.

### TECHNICAL FIELD

This application relates to geophysical exploration, and more particularly to an inversion method and system for seismic wavelet and reflection coefficient.

### BACKGROUND

Inversion of seismic wavelet and reflection coefficient plays an important role in seismic data processing and interpretation, including high-resolution processing and seismic wave impedance inversion. Currently, the inversion of seismic wavelet and reflection coefficient mainly struggles with the non-stationarity of seismic records and the ill-posedness of the seismic wavelet and reflection coefficient inversion.

The common methods to overcome the non-stationarity of seismic records include segmentation with overlap, quality factor compensation, and deep learning compensation. There are also various methods for overcoming the ill-posedness of the seismic wavelet inversion, such as phase correction, compressed mapping operator, L₁-norm sparse regularization, total variation regularization, and deep-learning inversion. The existing methods for overcoming the ill-posedness of the reflection coefficient inversion mainly include inversion of position and amplitude of reflection coefficients after fixing the number of nonzero reflection coefficients, L₁-norm sparse regularization, construction of a homogeneous linear equation system based on multi-trace reflection coefficients, L₀-norm constraint based on the number of envelope peaks, and deep-learning inversion.

The current seismic wavelet and reflection coefficient inversion methods have the following shortcomings.
(1) Inversion methods based on deep learning generally require appropriate labeled data to reach desirable inversion results. However, the practical logging data is relatively insufficient, and it is difficult to match the logging data with seismic data.
(2) Inversion methods based on regularization terms and constraint terms often require selection of appropriate parameters. Nevertheless, the selection based on manual test is not suitable for the large-scale industrial application, and the selection approaches based on L-curve and generalized cross-validation are computationally expensive.
(3) For the reflection coefficient inversion, applying lateral constraints may lead to distortion in the region with strong discontinuity, while in the absence of the lateral constraints, the lateral continuity of reflection coefficients obtained based on L₁-norm regularization or L₀-norm constraint needs improvement.

### SUMMARY

To overcome at least one of the above deficiencies in the prior art or provide at least one commercially useful alternative, the present disclosure provides an inversion method of seismic wavelets and reflection coefficients. In the inversion method provided in the present disclosure, it is assumed that the seismic wavelets have compact support and are smooth, and the reflection coefficients are relatively sparse. By using the alternating iteration, the joint inversion problem of the seismic wavelets and the reflection coefficients based on compact smoothness and relative sparseness is divided into a seismic wavelet inversion subproblem and a reflection coefficient inversion subproblem, which are solved using a proximal algorithm. The inversion method provided herein has easy selection of optimal parameters, and can obtain reflection coefficients with high resolution and good lateral continuity. Another object of the present disclosure is to provide an inversion system of seismic wavelets and reflection coefficients.

The technical solutions of the present disclosure are described below.

In a first aspect, this application provides an inversion method of seismic wavelets and reflection coefficients, comprising:
(S1) acquiring and preprocessing pre-stack seismic record data to form post-stack seismic record data, wherein the post-stack seismic record data comprises multi-trace post-stack seismic record sub-data;
(S2) averaging the multi-trace post-stack seismic record sub-data to generate averaged post-stack seismic trace data; smoothing an amplitude spectrum of the averaged post-stack seismic trace data to form an initial zero-phase wavelet; setting an initial reflection coefficient sequence as zero; and at the beginning of iteration of the seismic wavelets and reflection coefficients, setting the initial zero-phase wavelet and the initial reflection coefficient sequence as a newest wavelet and a newest reflection coefficient sequence, respectively;
(S3) finding an optimal solution of a reflection coefficient optimization problem with a relative sparsity constraint based on the newest wavelet by using a reflection coefficient proximal algorithm to form a newer reflection coefficient sequence;
(S4) finding an optimal solution of a wavelet optimization problem with a compact support constraint and a total variation (TV) smooth regularization term based on the newer reflection coefficient sequence by using a wavelet proximal algorithm to form a newer wavelet; and
(S5) determining whether the iteration of the seismic wavelets and reflection coefficients satisfies a termination condition; if yes, outputting the newest wavelet and the newest reflection coefficient sequence; otherwise, returning to step (S3).

In the inversion method provided herein, it is assumed that the seismic wavelets are compactly-supported and smooth, and the reflection coefficients are relatively sparse. By using alternate iterations, the joint inversion problem of the seismic wavelets and the reflection coefficients, which is based on compact smoothness and relative sparseness, is divided into a seismic wavelet inversion subproblem and a reflection coefficient inversion subproblem. The two subproblems are solved using a proximal algorithm. The inversion method provided herein has the advantages of easy selection of optimal parameters, high resolution of the reflection coefficients obtained from the inversion, and good lateral continuity.

In some embodiments, the step of smoothing an amplitude spectrum of the averaged post-stack seismic trace data to form an initial zero-phase wavelet comprises: averaging the multi-trace post-stack seismic record sub-data to generate the averaged post-stack seismic trace data;
smoothing a Fourier amplitude spectrum of the averaged post-stack seismic trace data to obtain an amplitude spectrum of the initial zero-phase wavelet; and
performing an inverse Fourier transform with the amplitude spectrum of the initial zero-phase wavelet being a Fourier transform of the initial zero-phase wavelet, so as to obtain the initial zero-phase wavelet, which is expressed as follows:

$${w}_{0} = IFFT ( \text{?} ( abs ( FFT ( \frac{1}{\text{?}} \text{?} ) ) ) ) ; \qquad ( 1 )$$

$$\text{?} \text{indicates text missing or illegible when filed}$$

wherein Nₜᵣ represents the number of traces of a post-stack seismic record; dᵢ represents an i^{th}-trace post-stack seismic record; n represents the number of sampling time points of a seismic record; ┌␣┐ represents an upper bound-taking function; and smooth^{┌n/4┐}(□) represents an operation for successively performing seven-point cubic polynomial smoothing ┌n/4┐ times on the amplitude spectrum.

In some embodiments, the step of finding an optimal solution of a reflection coefficient optimization problem with a relative sparsity constraint based on the newest wavelet by using a reflection coefficient proximal algorithm to form a newer reflection coefficient sequence comprises:

constructing the reflection coefficient optimization problem with the relative sparsity constraint, expressed as:

$${arg min}_{{r}_{i}} \frac{1}{2 {N}_{tr}} {\sum }_{i = 1}^{{N}_{tr}} {‖ {d}_{i} - {T}_{w} {r}_{i} ‖}_{2}^{2} , \qquad ( 2 ) ;$$

$$s . t . \vert {r}_{i , nonzero}^{min} \vert \geq {c}_{r} \vert {r}_{i , nonzero}^{max} \vert ,$$

wherein T_{w} represents a Toeplitz matrix corresponding to a wavelet w; rᵢ represents an i^{th}-trace reflection coefficient sequence; r_{i,nonzero}^{min} nonzero represents a component with a minimum absolute amplitude in i^{th}-trace non-zero reflection coefficients, and r_{i,nonzero}^{max} represents a component with a maximum absolute amplitude in the i^{th}-trace non-zero reflection coefficients; and cᵣ represents a relative sparsity parameter.

In some embodiments, cᵣ is selected from a range of 0.001≤cᵣ≤0.01.

In some embodiments, the step of finding an optimal solution of a wavelet optimization problem with a compact support constraint and a TV smooth regularization term based on the newer reflection coefficient sequence by using a wavelet proximal algorithm to form a newer wavelet comprises:

constructing the wavelet optimization problem with the compact support constraint and the TV smooth regularization term, expressed as:

$${arg min}_{w} \frac{1}{2 {N}_{tr}} {\sum }_{i = 1}^{{N}_{tr}} {‖ {d}_{i} - {T}_{w} {r}_{i} ‖}_{2}^{2} + {λ}_{w} {\sum }_{k = - m + 2}^{m - 1} \vert {w}_{k} - {w}_{k - 1} \vert , \qquad ( 3 ) ;$$

$$s . t . m = min ( ⌈ 0.6 {N}_{{f}_{0}} / ( {f}_{0} Δ t ) ⌉ , n ) ,$$

$${‖ w ‖}_{0} \leq min ( {N}_{{f}_{0}} / ( {f}_{0} Δ t ) , 2 m - 3 ) ,$$

wherein λ_{w} represents a coefficient of the TV smooth regularization term normalized by the number of seismic traces; Δt represents a sampling time interval; f₀ represents an estimated main frequency of seismic data obtained by averaging peak frequencies of individual traces of the seismic data; ∥w∥₀ represents a zero-norm of the wavelet w; N_{f}_{₀} is a parameter representing the number of non-zero components of a wavelet after normalized by the number of sampling points in a dominant period; and a wavelet length is set to 2 m−1.

In some embodiments, λ_{w} is selected from a range of 0.001≤λ_{w}≤0.01; and N_{f}_{₀} is a positive integer selected from 1-5.

In some embodiments, the pre-stack seismic data is preprocessed through amplitude-preserving denoising, true amplitude recovery, static correction, or a combination thereof.

In some embodiments, the post-stack seismic record data comprises data of each trace of a post-stack seismic record.

In a second aspect, this application provides an inversion system for implementing the aforementioned inversion method.

Compared to the prior art, this application has the following beneficial effects.

In the inversion method of the present disclosure, a compact smooth constraint is introduced into the wavelet inversion, and a relative sparsity constraint is introduced into the reflection coefficient inversion, so that the parameters of the inversion method provided herein are easy to select, and the resultant reflection coefficients have a good lateral continuity. Compared with the Toeplitz-Sparse Matrix Factorization (TSMF) wavelet and reflection coefficient inversion method, the inversion method provided herein can obtain inversion results with better lateral continuity for the reflection coefficient and better agreement with the characteristics of the geological structure through a more efficient parameter selection. Further, the efficient parameter selection can provide technical support for large-scale industrialized application of the wavelet and reflection coefficient inversion, and the inversion results whose reflection coefficients have better lateral continuity and are more consistent with the characteristics of geological formations can provide more accurate technical support for the oil and gas exploration.

Additional aspects and advantages of the present disclosure will be described below, part of which will be apparent from the following description or be understood through the implementation of the present disclosure.

### BRIEF DESCRIPTION OF THE DRAWINGS

The foregoing and/or additional aspects and advantages of the present disclosure will be apparent and readily understood from the description of embodiments with reference to the following accompanying drawings.

FIG. 1 is a flow chart of an inversion method of seismic wavelets and reflection coefficients according to an embodiment of the present disclosure;

FIG. 2 is a two-dimensional (2D) profile image of a field seismic record at an offshore location according to an embodiment of the present disclosure;

FIG. 3 illustrates a reflection coefficient sequence obtained using a comparison method according to an embodiment of the present disclosure;

FIG. 4 illustrates a reflection coefficient sequence obtained using the inversion method according to an embodiment of the present disclosure;

FIG. 5 shows comparison among spectra of the original seismic record, the reflection coefficient obtained by the comparison method, and the reflection coefficient obtained by the inversion method according to one embodiment of the present disclosure; and

FIGS. 6a and 6b respectively show wavelets obtained by the comparison method and the inversion method according to an embodiment of the present disclosure.

### DETAILED DESCRIPTION OF EMBODIMENTS

Embodiments of the present disclosure will be described in detail below, and are exemplarily shown in the accompanying drawings, where the same or similar labels denote the same or similar elements or elements having the same or similar function throughout the drawings. The following embodiments described with reference to the accompanying drawings are merely illustrative of the present disclosure, and thus cannot be construed as limitations to the present disclosure.

The seismic wavelet and reflection coefficient inversion can obtain seismic wavelet and reflection coefficient sequences by processing post-stack seismic data, which is an important means for high-resolution processing of seismic data and seismic wave impedance inversion. In this application, it is assumed that the seismic wavelet has compact support and is smooth, and the reflection coefficients are relatively sparse, so as to construct corresponding optimization problems of wavelet and reflection coefficient inversion. Then the corresponding optimization problems are solved by the alternating iteration and the proximal algorithm, thereby ultimately obtaining the seismic wavelet and reflection coefficient inversion method. The inversion method provided herein has easy selection of optimal parameters, and can obtain reflection coefficients with good lateral continuity.

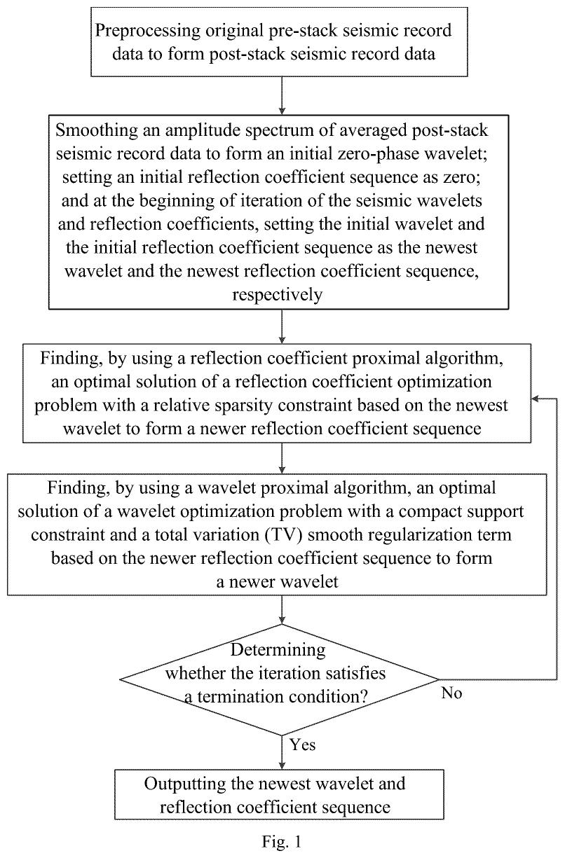

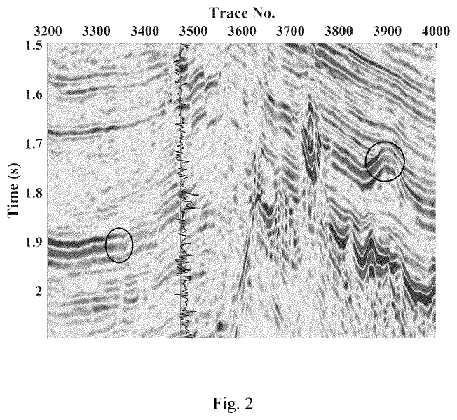

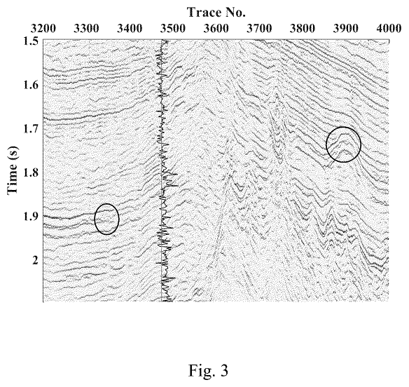

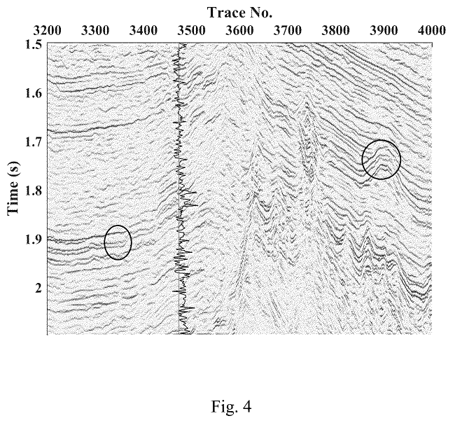

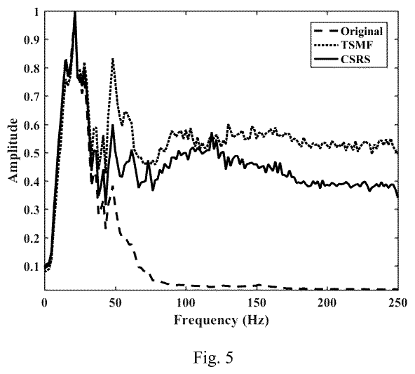

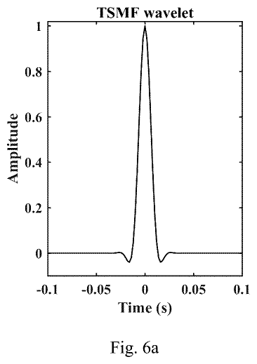

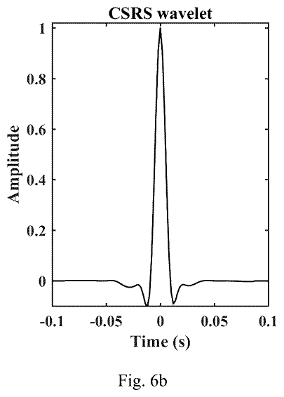

FIG. 1 is a flow chart of an inversion method of seismic wavelets and reflection coefficients according to an embodiment of the present disclosure. FIG. 2 is a two-dimensional (2D) profile image of a field seismic record at an offshore location according to an embodiment of the present disclosure. FIG. 3 illustrates a reflection coefficient sequence obtained using a comparison method according to an embodiment of the present disclosure. FIG. 4 illustrates a reflection coefficient sequence obtained using the inversion method according to an embodiment of the present disclosure. FIG. 5 shows comparison among spectra of the original seismic record, the reflection coefficient obtained by the comparison method, and the reflection coefficient obtained by the inversion method according to one embodiment of the present disclosure. FIGS. 6a and 6b respectively show wavelets obtained by the comparison method and the inversion method according to an embodiment of the present disclosure. Referring to FIGS. 1-6, the present disclosure provides an inversion method for seismic wavelets and reflection coefficients, which includes the following steps.

(S1) Pre-stack seismic record data is acquired and are preprocessed to form post-stack seismic record data, where the post-stack seismic record data includes multi-trace post-stack seismic record sub-data.

Specifically, the acquired seismic record data may be preprocessed through amplitude-preserving denoising, true amplitude recovery, and static correction to obtain post-stack seismic record data with a high signal-to-noise ratio (SNR). In some embodiments, the acquired seismic record data may be preprocessed through the amplitude-preserving denoising, the true amplitude recovery, and static correction, or a combination thereof for superposition to obtain more accurate post-stack seismic record data. In this embodiment, the post-stack seismic record data is denoted as {dᵢ}, i=1, 2, . . . , Nₜᵣ, where Nₜᵣ represents the number of traces of a post-stack seismic record. In an embodiment, the post-stack seismic record data may include each trace of the post-stack seismic record data, i.e., each trace of the post-stack seismic record data forms a post-stack seismic record data set. In other embodiments, the post-stack seismic record data may also consist of a part of each trace of the post-stack seismic record data.

(S2) The multi-trace post-stack seismic record sub-data is averaged to generate averaged post-stack seismic trace data. An amplitude spectrum of the averaged post-stack seismic trace data is smoothed to form an initial zero-phase wavelet, and at the same time, an initial reflection coefficient sequence is set as zero, and at the beginning of iteration of the wavelet and reflection coefficients, the initial zero-phase wavelet and the initial reflection coefficient sequence are set as the newest wavelet and the newest reflection coefficient sequence, respectively.

Specifically, a Fourier amplitude spectrum of the averaged post-stack seismic trace data is smoothed to obtain an amplitude spectrum of the initial zero-phase wavelet, and then an inverse Fourier transform is performed with the amplitude spectrum of the initial zero-phase wavelet being the Fourier transform of the initial wavelet, so as to obtain the initial zero-phase wavelet, which is expressed as follows:

$${w}_{0} = IFFT ( \text{?} ( abs ( FFT ( \frac{1}{\text{?}} \text{?} ) ) ) ) ; \qquad ( 1 )$$

$$\text{?} \text{indicates text missing or illegible when filed}$$

where n denotes the number of sampling time points of a seismic record; ┌□┐ represents an upper bound-taking function; smooth^{┌n/4┐}(□) represents an operation for successively performing seven-point cubic polynomial smoothing ┌n/4┐ times on the amplitude spectrum; and rᵢ⁽⁰⁾=0, i=1, 2, . . . , Nₜᵣ represents an initial reflection coefficient sequence; and the number of iteration is initialized as k=0.

In a specific implementation, at the beginning of the iteration of the wavelets and reflection coefficients, the initial wavelet and the initial reflection coefficients are set as the newest wavelet and the newest reflection coefficient sequence, respectively, so as to facilitate the subsequent iterative operations.

(S3) An optimal solution of a reflection coefficient optimization problem with a relative sparsity constraint is found based on the newest wavelet by using a reflection coefficient proximal algorithm to form a newer reflection coefficient sequence.

Specifically, it is assumed that the newest wavelet is w^{(k)}, and construct the following reflection coefficient optimization problem with relative sparsity constraints:

$${arg min}_{{r}_{i}} \frac{1}{2 {N}_{tr}} {\sum }_{i = 1}^{{N}_{tr}} {‖ {d}_{i} - {T}_{w} {r}_{i} ‖}_{2}^{2} , \qquad ( 2 ) ;$$

$$s . t . \vert {r}_{i , nonzero}^{min} \vert \geq {c}_{r} \vert {r}_{i , nonzero}^{max} \vert ,$$

where T_{w} represents a Toeplitz matrix corresponding to the wavelet w^{(k)}; r represents an i^{th}-trace reflection coefficient sequence; r_{i,nonzero}^{min} represents a component with a minimum absolute amplitude in the i^{th}-trace non-zero reflection coefficients; r_{i,nonzero}^{max} represents a component with a maximum absolute amplitude in the i^{th}-trace non-zero reflection coefficients; and cᵣ represents a relative sparsity parameter. For the high SNR seismic data after the amplitude-preserving denoising process, cᵣ is selected from a range of [0.001, 0.01]. In this embodiment, cᵣ is 0.005. Since the reflection coefficient inversion of each trace is independent when the wavelet is fixed, the optimization problem (2) can be simplified to the following form:

$${arg min}_{r} {f}_{obj}^{r} ( r ) ▯ \frac{1}{2} {‖ d - {T}_{w} r ‖}_{2}^{2} , \qquad ( 4 ) ;$$

$$s . t . \vert {r}_{nonzero}^{min} \vert \geq {c}_{r} \vert {r}_{nonzero}^{max} \vert ,$$

where d and r represent a seismic record and a reflection coefficient sequence corresponding to the seismic record of any trace, respectively. The first-order Taylor expansion is performed at a search point s of f_{obj}^{r}(r) in the optimization problem (4), where the search point s can be determined by Nesterov's method based on iterative variables, and a proximal regularization term

$$\frac{L}{2} {‖ r - s ‖}_{2}^{2}$$

is added, where L represents a reciprocal of a iteration step length, so that the optimization problem (4) can be transformed into the following form:

$${arg min}_{r} {prox}_{L , s}^{r} ( r ) = {f}_{obj}^{r} ( s ) + 〈 {T}_{w}^{T} ( {T}_{w}^{T} s - d ) , r - s 〉 + \frac{L}{2} {‖ r - s ‖}_{2}^{2} , \qquad ( 5 ) .$$

$$s . t . \vert {r}_{nonzero}^{min} \vert \geq {c}_{r} \vert {r}_{nonzero}^{max} \vert ,$$

According to the reflection coefficient proximal algorithm, the optimization problem (5) can be transformed into the following vector approximation problem:

$${arg min}_{r} \frac{1}{2} {‖ r - v ‖}_{2}^{2} , \qquad ( 6 ) ;$$

$$s . t . \vert {r}_{nonzero}^{min} \vert \geq {c}_{r} \vert {r}_{nonzero}^{max} \vert .$$

where v=s-T_{w}^{t}(T_{w}^{t}s-d)/L. Referring to the existing solutions about the fixed sparsity problem, the present disclosure gives the following solution about the vector approximation problem:

$${r}_{i} = \{ \begin{matrix}{v}_{i} - 0.5 \vert {[ v ]}_{K + 1} \vert , & {v}_{i} > \vert {[ v ]}_{K + 1} \vert , \\ {v}_{i} + 0.5 \vert {[ v ]}_{K + 1} \vert , & {v}_{i} < - \vert {[ v ]}_{K + 1} \vert , \\ 0 , & otherwise ,\end{matrix} ; \qquad ( 7 )$$

where K=min (n−1, N_{effect}^{v}); N_{effect}^{v} represents the number of components whose absolute amplitude is greater than cᵣ|v_{nonzero}^{max}| in v; and [v]_{K+1} represents a component with the (K+1)^{th}-largest absolute amplitude in v.

(S4) An optimal solution of a wavelet optimization problem with a compact support constraint and a total variation (TV) smooth regularization term is found based on the newer reflection coefficient sequence by using a wavelet proximal algorithm to form a newer wavelet.

Specifically, it is assumed that the newest reflection coefficient is {rᵢ^{(k+1)}} and a length of a wavelet is 2 m−1, understandably, greater than 0. The wavelet optimization problem with compact support constraints and TV smooth regularization term is constructed, as shown below:

$$\\ \begin{matrix}{arg min}_{w} \frac{1}{2 {N}_{tr}} {\sum }_{i = 1}^{{N}_{tr}} {‖ {d}_{i} - {T}_{w} {r}_{i} ‖}_{2}^{2} + {λ}_{w} {\sum }_{k = - m + 2}^{m - 1} \vert {w}_{k} - {w}_{k - 1} \vert , & ( 3 ) ;\end{matrix}$$

$$\\ s . t . m = min ( ⌈ 0.6 {N}_{f 0} / ( {f}_{0} Δ t ) ⌉ , n ) , {‖ w ‖}_{0} \leq min ( {N}_{f 0} / ( {f}_{0} Δ t ) , 2 m - 3 ) ,$$

where λ_{w} represents a coefficient of the TV smooth regularization term normalized by the number of seismic traces; Δt represents a sampling time interval; f₀ represents an estimated main frequency of seismic data obtained by averaging the peak frequencies of individual traces of the seismic data; ∥w∥₀ represents a zero-norm of the wavelet w, i.e., the number of non-zero components in the wavelet; N_{f}_{₀} is a parameter representing the number of non-zero components of the wavelet after normalized by the number of sampling points in a dominant period (corresponds to f₀). In particular, for the high SNR seismic data after the amplitude-preserving denoising process, λ_{w} is generally selected from the range of [0.001, 0.01], and N_{f}_{₀} is a positive integer from 1 to 5. In this embodiment, λ_{w} is 0.005, and N_{f}_{₀} is 3. m is fixed as min (┌0.6N_{f}_{₀}/(f₀Δt)┐, n), and the optimization problem (3) can be simplified into the following form using convolution symmetry:

$$\\ \begin{matrix}{arg min}_{w} {f}_{obj}^{{}_{} w} ( w ) ▯ {loss}^{{}_{} w} ( w ) + {λ}_{w} {\sum }_{k = - m + 2}^{m - 1} \vert {w}_{k} - {w}_{k - 1} \vert , & ( 8 ) ;\end{matrix}$$

$$\\ s . t . {‖ w ‖}_{0} \leq min ( {N}_{f 0} / ( {f}_{0} Δ t ) , 2 m - 3 ) ,$$

where

$$\\ {loss}^{{}_{} w} ( w ) {=}^{△} \frac{1}{2 {N}_{tr}} {\sum }_{i = 1}^{{N}_{tr}} {‖ {d}_{i} - {T}_{{r}_{i}} w ‖}_{2}^{2} ;$$

and Tᵣ_{ᵢ} is the matrix constructed by the middle 2m−1 columns of the following n×(2n−1) matrix Tᵣ_{ᵢ}:

$$\\ \begin{matrix}{\tilde{T}}_{{r}_{i}} = [ \begin{matrix}{r}_{i , n - 1} & {r}_{i , n - 2} & ⋯ & {r}_{i , 0} & 0 & ⋯ & 0 \\ 0 & {r}_{i , n - 1} & {r}_{i , n - 2} & ⋯ & {r}_{i , 0} & ⋱ & ⋮ \\ ⋮ & ⋱ & ⋱ & ⋱ & ⋱ & ⋱ & 0 \\ 0 & ⋯ & 0 & {r}_{i , n - 1} & {r}_{i , n - 2} & ⋯ & {r}_{i , 0}\end{matrix} ] , & ( 9 ) .\end{matrix}$$

Similarly to step (S3), the first-order Taylor expansion is performed at a search point s of loss^{w}(w), and a proximal regularization term

$$\\ \frac{L}{2} {‖ w - s ‖}_{2}^{2}$$

is added, so that the optimization problem (8) is transformed into the following form:

$$\\ \begin{matrix}{arg min}_{w} {prox}_{L , s}^{{}_{} w} ( w ) ▯ {loss}^{{}_{} w} ( s ) + 〈 \frac{1}{{N}_{tr}} {\sum }_{i = 1}^{{N}_{tr}} {T}_{{r}_{i}}^{{}_{} T} ( {T}_{{r}_{i}}^{{}_{} T} s - {d}_{i} ) , w - s 〉 + {λ}_{w} {\sum }_{k = - m + 2}^{m - 1} \vert {w}_{k} - {w}_{k - 1} \vert + \frac{L}{2} {‖ w - s ‖}_{2}^{2} , & ( 10 ) .\end{matrix}$$

$$\\ s . t . {‖ w ‖}_{0} \leq min ( {N}_{f 0} / ( {f}_{0} Δ t ) , 2 m - 3 ) .$$

According to the wavelet proximal algorithm, the optimization problem (10) can be transformed into the following vector approximation problem:

$$\\ \begin{matrix}{arg min}_{w} \frac{1}{2} {‖ w - v ‖}_{2}^{2} + \frac{{λ}_{w}}{L} {\sum }_{k = - m + 2}^{m - 1} \vert {w}_{k} - {w}_{k - 1} \vert , & ( 11 ) ;\end{matrix}$$

$$\\ s . t . {‖ w ‖}_{0} \leq min ( {N}_{f 0} / ( {f}_{0} Δ t ) , 2 m - 3 ) ,$$

where

$$\\ v = s - ( \frac{1}{{N}_{tr}} {\sum }_{i = 1}^{{N}_{tr}} {T}_{{r}_{i}}^{{}_{} T} ( {T}_{{r}_{i}}^{{}_{} T} s - {d}_{i} ) ) / L .$$

Similar to the solution for the Fused Lasso problem, the optimization problem (11) is transformed into the following nested optimization problem:

$$\\ \begin{matrix}{arg min}_{w} \frac{1}{2} {‖ w - \tilde{v} ‖}_{2}^{2} , s . t . {‖ w ‖}_{0} \leq min ( {N}_{f 0} / ( {f}_{0} Δ t ) , 2 m - 3 ) , & ( 12 ) ;\end{matrix}$$

$$\\ s . t . {‖ w ‖}_{0} \leq min ( {N}_{f 0} / ( {f}_{0} Δ t ) , 2 m - 3 ) ,$$

where:

$$\\ \begin{matrix}\tilde{v} = {arg min}_{w} \frac{1}{2} {‖ w - v ‖}_{2}^{2} + \frac{{λ}_{w}}{L} {\sum }_{k = - m + 2}^{m - 1} \vert {w}_{k} - {w}_{k - 1} \vert . & ( 13 ) .\end{matrix}$$

The optimization problem (13) is a typical TV regularization problem, which is solved by the classical iterative reweighted least squares (IRLS) method in the present disclosure. With reference to the solution for fixed sparsity constrained optimization problems, the optimization problem (12) can be solved in the following form:

$$\\ \begin{matrix}{w}_{i} = \{ \begin{matrix}{\tilde{v}}_{i} - 0.5 \vert {[ \tilde{v} ]}_{K + 1} \vert , {\tilde{v}}_{i} > \vert {[ \tilde{v} ]}_{K + 1} \vert , \\ {\tilde{v}}_{i} + 0.5 \vert {[ \tilde{v} ]}_{K + 1} \vert , {\tilde{v}}_{i} < - \vert {[ \tilde{v} ]}_{K + 1} \vert , \\ 0 , otherwise ,\end{matrix} & ( 14 ) ;\end{matrix}$$

where

$$\\ K = min ( {N}_{f 0} / ( {f}_{0} Δ t ) , 2 m - 3 ) .$$

(S5) Judge whether the iteration of the seismic wavelets and reflection coefficient satisfies a termination condition; if yes, the newest wavelet and the newest reflection coefficient sequence obtained by the final inversion are output, otherwise, return to step (S3).

Specifically, the number of iterations is updated as k=k+1 to determine whether the iteration satisfies the termination condition (usually selected as the L₂-norm error between the latest wavelet and the wavelet of the last iteration is less than a certain threshold), and if yes, the wavelet and the reflection coefficient sequence obtained by the final inversion are output, otherwise, return to step (S3). Overall, the inversion method of seismic wavelets and reflection coefficients provided in the present disclosure is continuously iterated through steps (S3) and (S4). In one embodiment, a new reflection coefficient {rᵢ^{(k+1)}} is formed by solving the optimal solution of the reflection coefficient optimization problem with relative sparsity constraints through the reflection coefficient proximal algorithm using the newest wavelet w^{(k)}, which is regarded as the newest reflection coefficient sequence later. Then the reflection coefficient sequence {rᵢ^{(k+1)}} is used to solve the optimal solution of the wavelet optimization problem with the compact support constraints and the total-variation smooth regularization term using a wavelet proximal algorithm to form a new wavelet w^{(k+1)}, which is further used by the reflection coefficient proximal algorithm to form the newer reflection coefficient sequence {rᵢ^{(k+2)}}. Then the newer reflection coefficient sequence {rᵢ^{(k+2)}} is used to form the newer wavelet w^{(k+2)} by the wavelet proximal algorithm. The iterative process is repeated until the L₂-norm error between the newest wavelet and the wavelet of the last iteration is less than the certain threshold.

The present disclosure also provides an inversion system for implementing the inversion method described above.

Tests for field seismic data are described below.

In this section, field seismic data are used and the compact smoothness and relative sparsity (CSRS) method proposed in the present disclosure is verified by comparing with the commonly used Toeplitz-Sparse Matrix Factorization (TSMF) seismic wavelet and reflection coefficient inversion method. Here, the parameters in the CSRS method proposed in the present disclosure use the fixed default parameters described above. FIG. 2 illustrates a 2D profile of field post-stack seismic data from an offshore site, which consists of 801 traces, and is intercepted over a time range of 1498-2096 ms with a time sampling interval of 2 ms. The logging data is located at the 275^{th} trace. The reflection coefficient profiles obtained by the TSMF and CSRS methods are illustrated in FIGS. 3 and 4, respectively. By Comparing FIGS. 3 and 4, it can be found that when using fixed default parameters, the CSRS method can obtain reflection coefficient profiles with higher resolution (i.e., clearer geological formations) and better lateral continuity (i.e., more consistent with geological formations) than that obtained by the TSMF method. FIG. 5 shows a comparison of the amplitude spectra of the original seismic data, the reflection coefficient profile obtained by the TSMF method, and the reflection coefficient profile obtained by the CSRS method. FIG. 5 shows that the CSRS method can better preserve the low and mid-frequency part of the seismic data (i.e., the fidelity of the obtained reflection coefficient is better) compared with the TSMF method, while effectively broadening the high frequencies. FIGS. 6a and 6b show the corresponding wavelet comparison, which shows that the CSRS method can obtain reasonable seismic wavelets similar to the shape of the Ricker wavelet.

It should be noted that better lateral continuity means better spatial lateral continuity of reflection coefficients. And since the field data do not have real seismic wavelets as comparisons, the general wavelet inversion of the field data is often required to be able to obtain reasonable seismic wavelets similar to the shape of the Ricker wavelet. In addition, although the wavelets obtained by the TSMF method are smoother than those obtained by the CSRS method, it is not necessarily the case that the smoother wavelets are more reasonable due to the complexity of the wavelets of the field seismic source and the attenuation effect of the strata on the wavelets. In fact, due to the better lateral continuity of reflection coefficients corresponding to the wavelets obtained by the CSRS method (which is more in line with the geological tectonic features), the wavelets obtained by the method provided in the present disclosure may be closer to the field seismic wavelets.

As used herein, terms, such as “an embodiment”, “some embodiments”, “an example”, “specific examples”, or “some examples”, mean that the specific features, structures, materials, or characteristics described in conjunction with the embodiment or example are included in at least one embodiment or example of the present disclosure. In this specification, schematic expressions of the above terms do not necessarily refer to the same embodiment or example. Moreover, the specific features, structures, materials, or characteristics described may be combined in any one or more embodiments or examples in a suitable manner.

Although embodiments of the present disclosure have been shown and described above, it can be understood that described above are exemplary and are not intended to limit the present disclosure. Changes, modifications, substitutions, and variations made by one of ordinary skill in the art to the above embodiments without departing from the spirit of the present disclosure shall fall within the scope of the disclosure defined by the appended claims.

What is claimed is:

1. An inversion method for seismic wavelets and reflection coefficients, comprising:
(S1) acquiring and preprocessing pre-stack seismic record data to form post-stack seismic record data, wherein the post-stack seismic record data comprises multi-trace post-stack seismic record sub-data;
(S2) averaging the multi-trace post-stack seismic record sub-data to generate averaged post-stack seismic trace data; smoothing an amplitude spectrum of the averaged post-stack seismic trace data to form an initial zero-phase wavelet; setting an initial reflection coefficient sequence as zero; and at the beginning of iteration of the seismic wavelets and reflection coefficients, setting the initial zero-phase wavelet and the initial reflection coefficient sequence as a newest wavelet and a newest reflection coefficient sequence, respectively;
(S3) finding an optimal solution of a reflection coefficient optimization problem with a relative sparsity constraint based on the newest wavelet by using a reflection coefficient proximal algorithm to form a newer reflection coefficient sequence;
(S4) finding an optimal solution of a wavelet optimization problem with a compact support constraint and a total variation (TV) smooth regularization term based on the newer reflection coefficient sequence by using a wavelet proximal algorithm to form a newer wavelet; and
(S5) determining whether the iteration of the seismic wavelets and reflection coefficients satisfies a termination condition; if yes, outputting the newest wavelet and the newest reflection coefficient sequence; otherwise, returning to step (S3).

2. The inversion method of claim 1, wherein the step of smoothing an amplitude spectrum of the averaged post-stack seismic trace data to form an initial zero-phase wavelet comprises:
averaging the multi-trace post-stack seismic record sub-data to generate the averaged post-stack seismic trace data;
smoothing a Fourier amplitude spectrum of the averaged post-stack seismic trace data to obtain an amplitude spectrum of the initial zero-phase wavelet; and
performing an inverse Fourier transform with the amplitude spectrum of the initial zero-phase wavelet being a Fourier transform of the initial zero-phase wavelet, so as to obtain the initial zero-phase wavelet, which is expressed as follows:
$$\\ \begin{matrix}{w}_{0} = IFFT ( {smooth}^{{}_{} ⌈ n / 4 ⌉} ( abs ( FFT ( \frac{1}{{N}_{tr}} {\sum }_{i = 1}^{{N}_{tr}} {d}_{i} ) ) ) ) ; & ( 1 )\end{matrix}$$
wherein Nₜᵣ represents the number of traces of the post-stack seismic record data; dᵢ represents an i^{th}-trace post-stack seismic record; n represents the number of sampling time points of a seismic record; ┌□┐ represents an upper bound-taking function; and smooth^{┌n/4┐}(□) represents an operation for successively performing seven-point cubic polynomial smoothing ┌n/4┐ times on the amplitude spectrum.

3. The inversion method of claim 1, wherein the step of finding an optimal solution of a reflection coefficient optimization problem with a relative sparsity constraint based on the newest wavelet by using a reflection coefficient proximal algorithm to form a newer reflection coefficient sequence comprises:
constructing the reflection coefficient optimization problem with the relative sparsity constraint, expressed as:
$$\\ \begin{matrix}{arg min}_{{r}_{i}} \frac{1}{2 {N}_{tr}} {\sum }_{i = 1}^{{N}_{tr}} {‖ {d}_{i} - {T}_{w} {r}_{i} ‖}_{2}^{2} , s . t . \vert {r}_{i , nonzero}^{{}_{} min} \vert \geq {c}_{r} \vert {r}_{i , nonzero}^{{}_{} max} \vert , & ( 2 ) ;\end{matrix}$$
wherein T_{w} represents a Toeplitz matrix corresponding to a wavelet w; rᵢ represents an i^{th}-trace reflection coefficient sequence; r_{i,nonzero}^{min} represents a component with a minimum absolute amplitude in i^{th}-trace non-zero reflection coefficients, and r_{i,nonzero}^{max} represents a component with a maximum absolute amplitude in the i^{th}-trace non-zero reflection coefficients; and cᵣ represents a relative sparsity parameter.

4. The inversion method of claim 3, wherein cᵣ is selected from a range of 0.001≤cᵣ≤0.01.

5. The inversion method of claim 3, wherein the step of “finding an optimal solution of a wavelet optimization problem with a compact support constraint and a TV smooth regularization term based on the newer reflection coefficient sequence by using a wavelet proximal algorithm to form a newer wavelet” comprises:
constructing the wavelet optimization problem with the compact support constraint and the TV smooth regularization term, expressed as:
$$\\ \begin{matrix}{arg min}_{w} \frac{1}{2 {N}_{tr}} {\sum }_{i = 1}^{{N}_{tr}} {‖ {d}_{i} - {T}_{w} {r}_{i} ‖}_{2}^{2} + {λ}_{w} {\sum }_{k = - m + 2}^{m - 1} \vert {w}_{k} - {w}_{k - 1} \vert , & ( 3 ) ;\end{matrix}$$
$$\\ s . t . m = min ( ⌈ 0.6 {N}_{f 0} / ( {f}_{0} Δ t ) ⌉ , n ) , {‖ w ‖}_{0} \leq min ( {N}_{f 0} / ( {f}_{0} Δ t ) , 2 m - 3 ) ,$$
wherein λ_{w} represents a coefficient of the TV smooth regularization term normalized by the number of seismic traces; Δt represents a sampling time interval; f₀ represents an estimated main frequency of seismic data obtained by averaging peak frequencies of individual traces of the seismic data; ∥w∥₀ represents a L₀-norm of the wavelet w; N_{f}_{₀} is a parameter representing the number of non-zero components of a wavelet after normalized by the number of sampling points in a dominant period; and
a wavelet length is set to 2m−1.

6. The inversion method of claim 5, wherein λ_{w} is selected from a range of 0.001≤λ_{w}≤0.01; and N_{f}_{₀} is a positive integer selected from 1-5.

7. The inversion method of claim 1, wherein the pre-stack seismic record data is preprocessed through amplitude-preserving denoising, true amplitude recovery, static correction, or a combination thereof.

8. The inversion method of claim 1, wherein the post-stack seismic record data comprises data of each trace of a post-stack seismic record.

9. A system for implementing the inversion method of claim 1.
